(19) United States
(12) Patent Application Publication
(10) Pub. No.: US 2009/0247101 A1
(43) Pub. Date: Oct. 1, 2009

(54) Auto-detection of broadcast channel spacing

(76) Inventors: Ligang Zhang, Shenzhen (CN); Steve W. Hanawalt, Austin, TX (US); Greg Hodgson, Austin, TX (US); Liang Wu, Shenzhen (CN)

Correspondence Address: O'KEEFE, EGAN, PETERMAN & ENDERS LLP, 1101 CAPITAL OF TEXAS HIGHWAY SOUTH, #C200, AUSTIN, TX, 78746, US

(21) Appl. No.: 12/286,315

(22) Filed: Sep. 30, 2008

Related U.S. Application Data
(60) Provisional application No. 61/072,140, filed on Mar. 28, 2008.

(51) Int. Cl. H04B 1/18

(52) U.S. Cl. 455/182.3

(57) ABSTRACT

Methods and systems are disclosed for automatic detection of channel spacing for broadcast bands in different regions that use different channel spacing. Using the described embodiments, channel spacing at a users' current location can be automatically detected so that manual settings by the user are not necessary, especially when a user travels with his/her radio across regions that use different channel spacing for radio broadcasting bands. This auto-detected channel spacing can then be used for later channel searching by the radio. More particularly, methods and systems are disclosed for auto-detection of channel spacing for AM broadcasts using different channel spacings, such as the standard 9 kHz and 10 kHz spacings, used today in different geographic regions of the world for AM broadcast bands.

### RELATED APPLICATIONS

This application claims priority to the following co-pending provisional application: Provisional Application Ser. No. 61/072,140, filed on Mar. 28, 2008, and entitled “AUTO-DETECTION OF BROADCAST CHANNEL SPACING,” which is hereby incorporated by reference in its entirety.

### TECHNICAL FIELD OF THE INVENTION

This invention relates to broadcast receivers and, more particularly, to reception of channels within radio broadcast bands.

### BACKGROUND

Broadcast radio receivers are becoming more and more portable. For example, FM and AM receivers are being included within cellular telephones, portable media players, and other portable devices. Users who travel with portable devices, such as cellular telephones and portable media players, and desiring to tune to radio broadcasts within different countries can experience problems due to variations in broadcast bands throughout the world. For example, with respect to AM broadcast channels today, there exist two possibilities for the spacing of channels, namely a 9 kHz channel spacing starting with 522 kHz, as used in Europe and most of the world, and a 10 kHz channel spacing starting with 520 kHz as used in the United States. For the most part, possible stations for these two schemes do not overlap because of the two different channel spacings. Similarly, with respect to FM broadcast channels today, different geographic regions use different FM band channel spacings, such as a 50 kHz channel spacing, a 100 kHz channel spacing, or a 200 kHz channel spacing. If a device is tuning with the wrong spacing, one likely result is that few or no stations will be identified and tuned. In addition, if some stations are located using the wrong channel spacings, a customer may easily draw the wrong conclusion with respect to the appropriate receiver settings.

One prior solution to this problem of different AM channel spacings has been to search for channels in 1 kHz increments. With the channel spacing set to 1 kHz, channel searching can hit all potential stations for the possible channel spacing. This solution, however, results in slow and some cases intolerably slow scanning. In addition, while 1 kHz step seeking is possible with advanced DSP (digital signal processor) radios, it can cause serious false stop problems for many other radios, if it is possible at all.

### SUMMARY OF THE INVENTION

Methods and systems are disclosed for automatic detection of channel spacing for broadcast bands in different regions that use different channel spacing. Using the described embodiments, channel spacing at a users' current location can be automatically detected so that manual settings by the user are not necessary, especially when a user travels with his/her radio across regions that use different channel spacing for radio broadcasting bands. This auto-detected channel spacing can then be used for later channel searching by the radio. More particularly, methods and systems are disclosed for auto-detection of channel spacing for AM broadcasts using different channel spacings, such as the standard 9 kHz and 10 kHz spacings, used today in different geographic regions of the world for AM broadcast bands. Advantageously, the embodiments described herein allow users of portable devices, such as cellular telephones and portable media players, to travel anywhere in the world and receive AM stations without prior knowledge of which AM channel spacing is being utilized. As described below, other features and variations can be implemented, if desired, and a related systems and methods can be utilized, as well.

### DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1A is a block diagram for an embodiment including an auto-detection channel spacing module.

FIG. 1B is a process flow diagram for an auto-detection algorithm for channel spacing.

FIG. 2 is a block diagram for an embodiment of an AM receiver and host processor utilizing an auto-detection channel spacing module.

FIG. 3 is a process flow diagram for an auto-detection algorithm for AM channel spacing.

FIG. 4 is a process flow diagram for an alternative embodiment for an auto-detection algorithm for AM channel spacing.

### DETAILED DESCRIPTION OF THE INVENTION

Methods and systems are disclosed for automatic detection of channel spacing for broadcast bands in different regions that use different channel spacing. Using the described embodiments, channel spacing at a users' current location can be automatically detected so that manual settings by the user are not necessary, especially when a user travels with his/her radio across regions that use different channel spacing for radio broadcasting bands. This auto-detected channel spacing can then be used for later channel searching by the radio.

More particularly, methods and systems are disclosed for auto-detection of channel spacing for AM broadcasts using different channel spacings, such as the standard 9 kHz and 10 kHz spacings used today in different geographic regions of the world for AM broadcast bands. Advantageously, the embodiments described herein allow a user of a portable device, such as a cellular telephone or a portable media player, to travel anywhere in the world and receive AM stations without prior knowledge of which AM channel spacing is being utilized.

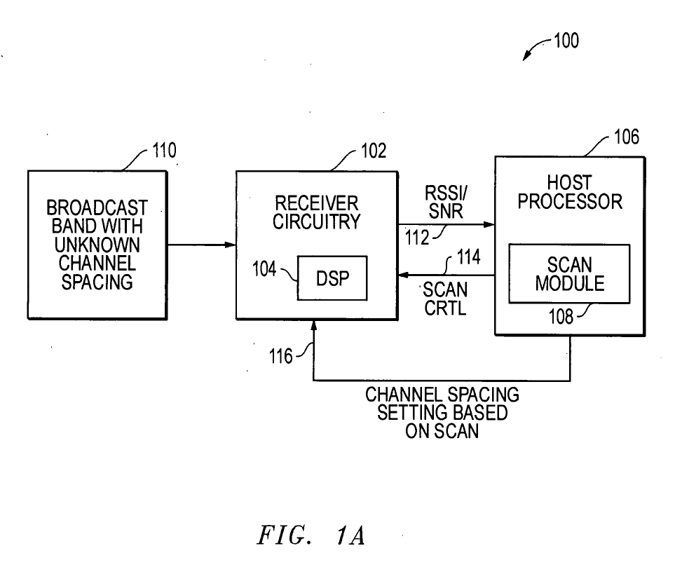

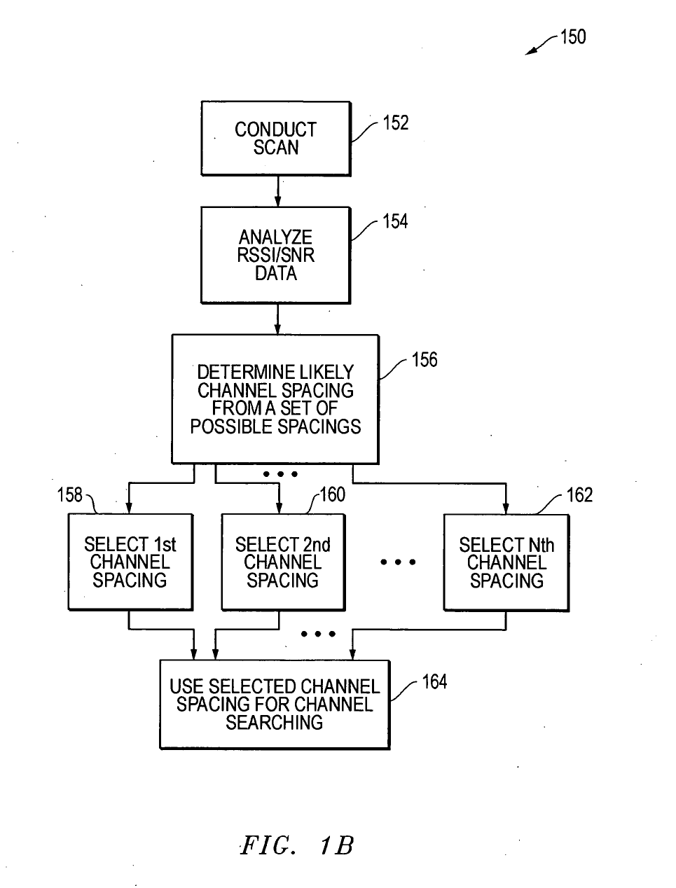

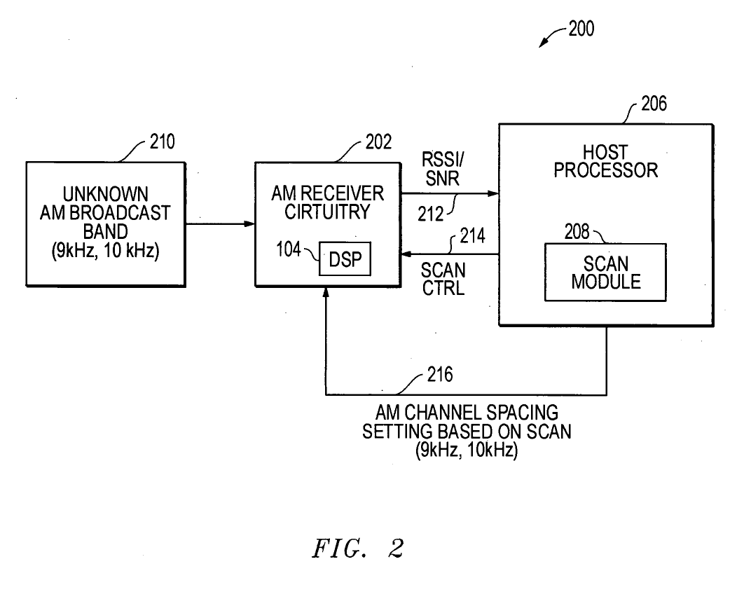

FIGS. 1A and 1B provide example embodiments for a system and method of automatically detecting channel spacing for any desired broadcast band where different regions use different channel spacing for that broadcast band. Embodiments more particularly directed to the AM broadcast band are discussed with respect to FIGS. 2, 3 and 4 below.

FIG. 1A is a block diagram of an embodiment 100 for auto-detection and selection of a channel spacing for a broadcast band. A broadcast band 110 with an unknown channel spacing is received by receiver circuitry 102, which includes digital signal processor (DSP) circuitry 104. The receiver circuitry 102 receives the broadcast band 110, tunes to a frequency (typically a broadcast channel) within the broadcast band 110, and converts the signals on this tuned frequency to digital information. The DSP circuitry 104 then processes this digital information, as desired. As described herein, the receiver circuitry 102 produces a receive signal strength indication (RSSI) signal and/or a signal-to-noise ratio (SNR) signal representing the signal strength and/or the noise level, respectively, on the tuned frequency. Examples of AM/FM receiver circuitry are described in U.S. Pat. No. 7,272,375, which is hereby incorporated by reference in its entirety.

The host processor 106 represents a processor that communicates with the receiver circuitry 102 to provide further processing of the received signals. In addition, the host processor 106 can provide other functionality to a user. For example, in a cellular telephone, the host processor 106 can operate to provide cellular telephone communications and/or data services to the user along with any other desired features. In a radio device or portable media player, the host processor 106 may simply provide for a user interface and radio control features to a user. As described herein, the host processor 106 includes a scan module 108 that operates to determine the channel spacing for the broadcast band 110. The scan module 108 sends scan control (CTRL) signals 114 to the receiver circuitry 102 to choose the frequencies within the broadcast band that are tuned. The scan module 108 then analyzes RSSI and/or SNR signals 112 received from the receiver circuitry 102 for the tuned frequencies. The scan module 108 can then make a determination of which one of a set of possible channel spacings is the likely channel spacing for the broadcast band 110. Based upon that determination, the host processor 106 provides a signal 116 to the receiver circuitry 102 that sets the channel spacing setting based on the scan. It is further noted that the host processor 106 and the receiver circuitry 102 could be included on the same integrated circuit or could be implemented in separate integrated circuits, as desired.

FIG. 1B is a process flow diagram of an embodiment 150 for auto-detection and selection of a channel spacing for a broadcast band. In block 152, a scan is conducted of a plurality of frequencies within the broadcast band. In block 154, RSSI and/or SNR data relating to these scanned frequencies are analyzed. In block 156, a determination is made concerning the likely channel spacing for the broadcast band from a set of possible spacings for that broadcast band. Next, the flow moves to the appropriate block among blocks 158, 160 . . . 162, depending upon the determination made in block 156. In block 158, a 1^{st} channel spacing is selected and set for the receiving circuitry. In block 160, a 2^{nd} channel spacing is selected and set for the receiving circuitry. And so on, until in block 162, an N^{th} channel spacing is selected and set for the receiving circuitry. Block 164 is then reached where the selected channel spacing is used for later channel searching. It is noted that while three or more channel spacings are represented in embodiment 150, as long as there are at least two possible channel spacings (N≧2), the embodiments described herein are advantageous.

As described in more detail below with respect to FIG. 2-4, AM broadcast bands in different geographic regions use different channel spacings. For example, with respect to AM broadcast channels today, there exist two possibilities for the spacing of channels, namely a 9 kHz channel spacing starting with 522 kHz, as used in Europe and most of the world, and a 10 kHz channel spacing starting with 520 kHz as used in the United States. Although not described with respect to the embodiments of FIGS. 2-4, FM broadcast bands in different geographic regions also use different channel spacings. For example, some geographic regions use an FM channel spacing of 50 kHz. Some geographic regions use an FM channel spacing of 100 kHz. And some geographic regions use an FM channel spacing of 200 kHz.

FIG. 2 is a block diagram of an embodiment 200 for auto-detection and selection of a channel spacing for an AM broadcast band. An AM broadcast band 210 with an unknown channel spacing (e.g., 9 kHz or 10 kHz) is received by receiver circuitry 202, which includes digital signal processor (DSP) circuitry 204. Similar to embodiment 100 above, the receiver circuitry 202 receives the AM broadcast band 210, tunes to a frequency (typically a broadcast channel) within the broadcast band 210, and converts the signals on this tuned frequency to digital information. The DSP circuitry 204 then processes this digital information, as desired. As described herein, the receiver circuitry 202 produces a receive signal strength indication (RSSI) signal and/or a signal-to-noise ratio (SNR) signal representing the signal strength and/or the noise level, respectively, on the tuned frequency.

The host processor 206 represents a processor that communicates with the receiver circuitry 202 to provide further processing of the received signals. Similar to embodiment 100, the host processor 206 can provide other functionality to a user. For example, in a cellular telephone, the host processor 206 can operate to provide cellular telephone communications and/or data services to the user along with any other desired features. In a radio device or a portable media player, the host processor 206 may simply provide for a user interface and radio control features to a user. As described herein, the host processor 206 includes a scan module 208 that operates to determine the channel spacing for the AM broadcast band 210. The scan module 208 sends scan control (CTRL) signals 214 to the receiver circuitry 202 to choose the frequencies within the broadcast band that are tuned. The scan module 208 then analyzes RSSI and/or SNR signals 212 received from the receiver circuitry 202 for the tuned frequencies. The scan module 208 can then make a determination of which one of a set of possible channel spacings is the likely channel spacing for the AM broadcast band 210. Based upon that determination, the host processor 206 provides a signal 216 to the receiver circuitry 202 that sets the channel spacing setting (e.g., 9 kHz or 10 kHz) based on the scan. It is further noted that the host processor 106 and the receiver circuitry 102 could be included on the same integrated circuit or could be implemented in separate integrated circuits, as desired.

It is noted that the scan modules 108 and 208 described above can implement frequency scans and RSSI/SNR analyses in a wide variety of ways in order to make a determination of the likely channel spacing for the broadcast band. For example, scans can be implemented that look for broadcast channels within the frequency band, that use possible channel spacings to conduct the scan, that scan only a portion of the band, that stop scanning once a certain number of valid stations have been indicated for a particular channel spacing, that start from the top of the band, that start from the bottom of the band, that scan the band at 1 kHz frequency steps looking for a valid stations to determine likely spacing, and/or other desired features. Advantageously, the embodiments described herein allow for automatic detection of the channel spacing by analyzing RSSI and/or SNR information on scanned frequencies to determine a likely channel spacing for the broadcast band.

One possible implementation is to scan from 520 kHz (which is currently the lowest possible AM station anywhere in the world) and up with pre-determined and varying steps so that the scanning up covers all potential stations across geographic regions for all possible channel spacings. Data for valid stations found on the way would be collected as the scan proceeded. A valid station, for example, could be one for which the RSSI data exceeded a threshold and/or SNR data exceeded a threshold value thereby indicating a strong station signal. Once a selected number of valid stations had been located and a decision could be made concerning the likely channel spacing, the auto-detect scan can stop. This technique of stopping the scan early based upon selected criteria, such as a selected number of valid stations found at a particular channel spacing, could potentially result in a considerable savings in scan time. The scan could also start from the top of the AM broadcast band (e.g., 1710 kHz for AM), but in most regions, AM stations are populated more on the lower end of the spectrum. As such, starting from the bottom of the AM broadcast band would likely result in quicker recognition of valid stations with which a determination could be made concerning likely channel spacing.

As indicated above, this technique could also be applied to broadcast bands other than the AM broadcast band. Once a predetermined number of stations are located at one channel spacing versus other possible channel spacings, the auto-detect scan can stop and a decision can be made to select that channel spacing. In addition, if desired, for the AM broadcast band and/or other broadcast bands being analyzed, stations that overlap between possible channel spacings for the broadcast band can be skipped in the scan process in order to reduce scanning time. These scan time savings can help improve the user experience.

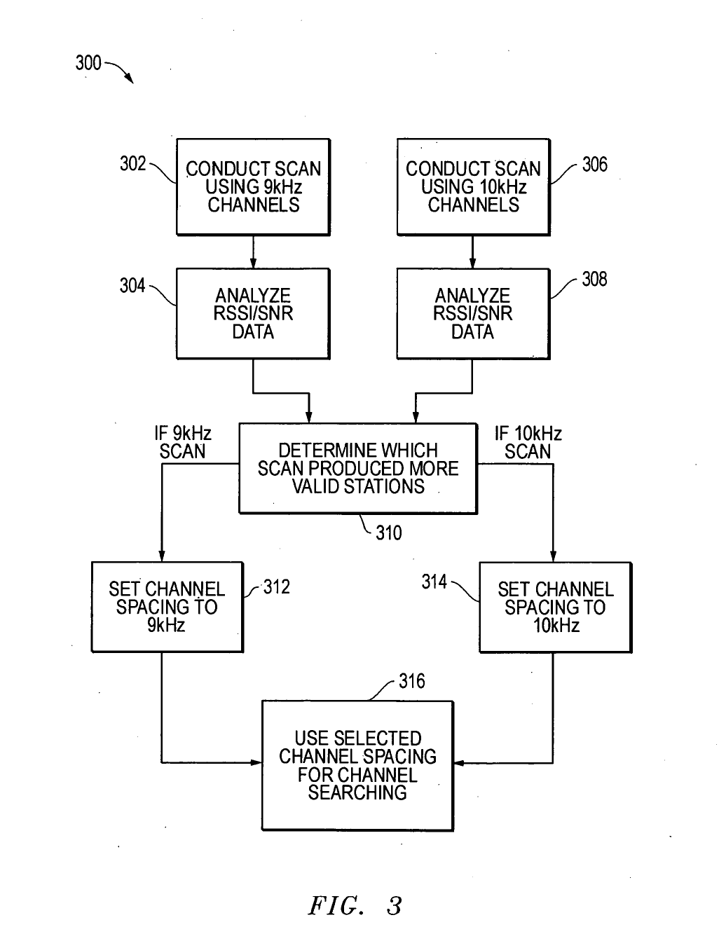

FIG. 3 provides process flow diagram for an embodiment 300 that uses scans at the possible channel spacings for the AM broadcast band to make a determination of which channel spacing (9 kHz, 10 kHz) is being used in the region in which the radio is located. In block 302, a scan is conducted using 9 kHz channel spacing as a frequency step starting, for example, at 522 kHz, which is the standard in Europe. In block 304, the RSSI/SNR data is analyzed for this scan. In block 306, a scan is conducted using 10 kHz channel spacing as a frequency step starting, for example, at 520 kHz, which is the standard in the United States. In block 308, the RSSI/SNR data is analyzed for this scan. In block 310, a determination is made concerning which scan produced more valid stations. If the 9 kHz scan produced more valid stations, flow passes to block 312 where the channel spacing is set to 9 kHz. If the 10 kHz scan produced more valid stations, flow passes to block 314 where the channel spacing is set to 10 kHz. In block 316, the selected channel spacing is used for later channel searching.

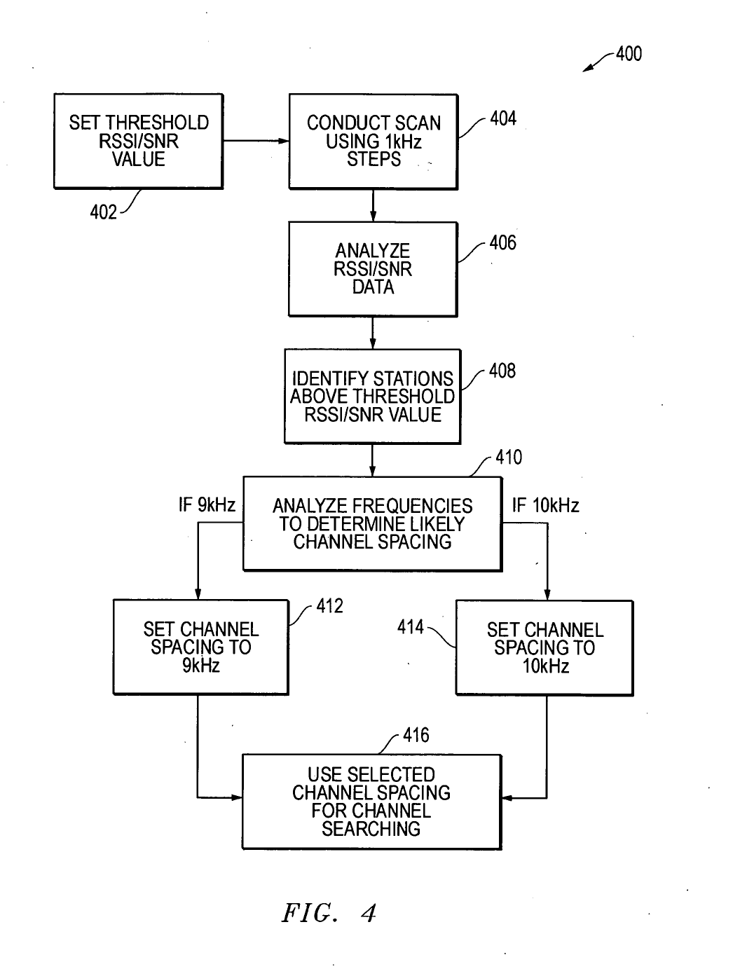

FIG. 4 provides a process flow diagram for an embodiment 400 that uses a 1 kHz scan across the broadcast band or a portion of the broadcast band to identify valid stations and to analyze frequency differences between these stations to make a determination of the likely channel spacing. In block 402, threshold value(s) are set for the RSSI/SNR values as an indication of when a valid station has been found at a frequency. In block 404, a scan is conducted using 1 kHz steps. This scan can be conducted across the entire AM broadcast band, across a selected portion of the AM broadcast band, or until a determination has been made of the likely channel spacing. In block 406, the RSSI/SNR data for the scanned frequency points are analyzed. In block 408, frequency points yielding signals above the RSSI/SNR threshold value(s) are identified as stations. In block 410, the frequencies of the identified stations are analyzed to determine the likely channel spacing. If the determination in block 410 is that a 9 kHz channel spacing is likely, then flow passes to block 412 where the receiver circuitry is set to a 9 kHz channel spacing. If the determination in block 410 is that a 10 kHz channel spacing is likely, then flow passes to block 412 where the receiver circuitry is set to a 10 kHz channel spacing. In block 416, the selected channel spacing is used for later channel searching.

It is noted that the processing conducted in block 404, 406, 408 and 410 could be implemented simultaneously such that RSSI/SNR data for scanned frequencies are being analyzed at the same time that new frequencies are being scanned. As such, the scan can be stopped when a determination has been made of the likely channel spacing. Alternatively, the scan can continue until a desired range of frequencies within the broadcast band have been scanned.

With respect to the AM broadcast band, it is noted that there are 14 possible stations that overlap between 9 kHz and 10 kHz steps. These overlapping stations effectively create dead zones for the detection algorithm in that a station at one of these points does not itself indicate which channel spacing is correct. Thus, if the only valid stations happen to fall at these points (i.e., 540/630/720/810/900/990/1080/1170/1260/1350/1440/1530/1620/1710 kHz) which are valid stations for both 9 kHz and 10 kHz channel spacings, it would be difficult for an algorithm to determine which spacing was correct. In addition, as indicated above, these frequency points can be skipped in the scanning process to provide scan time savings because it may be difficult to obtain helpful information from these overlapping stations. It is further noted that there are also 27 frequency points that are only 1 kHz away between 9 kHz and 10 kHz steps for valid stations. Similar to overlapping stations, these closely spaced stations between the two possible channel spacings could also be skipped, if desired, to reduce scan time. As with the AM broadcast band, solutions directed to determining a proper channel spacing between multiple possible channel spacings for other broadcast bands will likely want to consider these overlapping frequency points and closely spaced frequency points with respect to valid stations for the channel spacings.

Other possible auto-detection procedures also could be used. As further examples, the following procedures could be used for the AM broadcast band. It is further noted that these examples and the features of these examples could be used alone or in combination with each other depending upon the implementation desired.

### EXAMPLE A

Tune from 520 kHz and up with 10 kHz spacing across the entire AM band (stop at 1710 kHz); record the RSSI and/or SNR readings for all stronger stations found.
Tune from 522 kHz and up with 9 kHz spacing across the entire AM band (stop at 1710 kHz); record the RSSI and/or SNR readings for all stronger stations found.
Compare the number of stations found.
The scan yielding more valid stations being the right channel spacing setting.

### EXAMPLE B

The same as EXAMPLE A except the scans occur across a small portion of the broadcast band to make the determination (e.g., 100 kHz portion).

### EXAMPLE C

Tune from 520 kHz and up with 1 kHz steps.
Identify all frequency points with RSSI/SNR above certain threshold value(s) as valid stations.
Determine likely spacing from frequency differences between valid stations.

### EXAMPLE D

Same as EXAMPLE C, except that the strongest stations that are found are used for the channel spacing determination (e.g., best 5 stations)
Calculate the spacings from one to another for these strongest stations.
Combine this information with the location of the frequency points themselves for these best/strongest stations.
Use this information to make the channel spacing determination.

### EXAMPLE E

Same as EXAMPLE C except that the receiver circuitry can also be set with RSSI/SNR thresholds to allow for faster scanning.
For example, in a part where an SNR measurement is only done if a frequency meets an RSSI threshold and a valid station is typically deemed to exist if both RSSI and SNR thresholds are met, the RSSI threshold can be set to a value above the maximum possible reported RSSI level.
The result of this change would be that no frequency point would satisfy the RSSI threshold so that the SNR measurements would never be made, but the RSSI levels could still be recorded for each frequency and then analyzed to make a determination of possible valid stations and a determination of likely channel spacing.
This solution would allow for much faster scanning of frequency points (e.g., from about 200 ms/channel time down to about 50 ms/channel, depending upon the implementation of the receiver circuitry)

### EXAMPLE F

Once a valid station is found, the host processor could check the nearest valid frequencies of the other spacing and if the RSSI/SNR is higher it can be assumed that the other spacing is present.
For example, the tuner is currently set for 10 kHz spacing. A seek finds a station at 590 kHz. The host processor does another tune (1 kHz spacing) to 585 kHz and 594 kHz to see if the RSSI and SNR are better at any of those frequencies than it is at 590 kHz. If so, then a 9 kHz channel spacing could be selected.

### EXAMPLE G

Same as EXAMPLE A where a determination is made as long as 3 or more valid stations can be found at one of the possible channel spacings.

### EXAMPLE H

Tune across the entire band (or a portion of the band) in 1 kHz steps recording RSSI and/or SNR levels at every frequency.
Find the maximum RSSI (and maybe SNR) frequencies and use the delta between those maxima to make a determination of the channel spacing.

### EXAMPLE I

Same as EXAMPLE H, except instead of 1 kHz steps, only the possible valid 9 kHz channels and 10 kHz channels are scanned to reduce the scan time (i.e. 520 kHz, 522 kHz, 530 kHz, 531 kHz, etc.).

### EXAMPLE J

Same as EXAMPLE I, except that common stations between the channel spacings are skipped in the scan to reduce scan time. For the 9 kHz and 10 kHz channel spacings in the AM broadcast bands, these skipped overlapping stations could be, for example, 540/630/720/810/900/990/1080/1170/1260/1350/1440/1530/1620/1710 kHz.

### EXAMPLE K

Same EXAMPLE I, except that a decision concerning the proper channel spacing is made during the seek once enough channels are found to decide whether spacing is 9 kHz or 10 kHz.
The seek is continued using only the selected channel spacing for the region.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and architectures. For example, equivalent elements may be substituted for those illustrated and described herein, and certain features of the invention may be utilized independently of the use of other features, all as would be apparent to one skilled in the art after having the benefit of this description of the invention.

What is claimed is:

1. A method for auto-detection of channel spacings for AM broadcast bands, comprising:
scanning a plurality of possible channels for a plurality of AM broadcast bands, each AM broadcast band having a different channel spacing and representing a different geographic region;
determining receive signal information for the plurality of possible channels;
analyzing the receive signal information;
automatically selecting a channel spacing representing a selected AM broadcast band from the plurality of AM broadcast bands based upon the analyzed receive signal information; and
subsequently using the selected channel spacing to search for channels within the selected AM broadcast band.

2. The method of claim 1, wherein the plurality of AM broadcast bands comprises a first AM broadcast band for a first geographic region having a 9 kHz channel spacing and a second AM broadcast band for a second geographic region having a 10 kHz channel spacing associated with.

3. The method of claim 2, wherein the scanning step comprises scanning channels at the 9 kHz channel spacing and scanning channels at the 10 kHz channel spacing, wherein the determining step comprises determining a received signal strength for each scanned channel, wherein the analyzing step comprises comparing a number of channels for each spacing that exceed a threshold level of signal strength, and wherein the selecting step comprises selecting the 9 kHz channel spacing or the 10 kHz channel spacing based upon the channel spacing having more channels that exceed the threshold level.

4. The method of claim 3, further comprising scanning across an entire AM band for each channel spacing.

5. The method of claim 3, further comprising scanning only a portion of the AM band for each channel spacing.

6. The method of claim 3, further comprising skipping channels within the 9 kHz channel spacing and the 10 kHz channel spacing that are overlapping channels with respect to each other.

7. The method of claim 2, wherein the scanning step comprises scanning at 1 kHz spacing, wherein the determining step comprises determining a received signal strength for each scanned channel, wherein the analyzing step comprises identifying channels that exceed a threshold level of signal strength and determining frequency differences between identified channels, and wherein the selecting step comprises selecting the 9 kHz channel spacing or the 10 kHz channel spacing based upon the frequency differences.

8. The method of claim 7, wherein the analyzing step comprises identifying a selected number of channels having a strongest receive signal strength, and wherein the selecting step comprises selecting a channel spacing based upon a spacing for these selected number of channels.

9. The method of claim 7, further comprising skipping channels within the 9 kHz channel spacing and the 10 kHz channel spacing that are overlapping channels with respect to each other.

10. The method of claim 1, further comprising communicating scan control signals from a host processor to AM receiver circuitry and communicating receive signal information from the AM receiver circuitry to the host processor.

11. The method of claim 1, wherein the determining step comprises determining a received signal strength for each scanned channel.

12. The method of claim 1, wherein the determining step comprises determining signal-to-noise ratio for each scanned channel.

13. The method of claim 1, further comprising recording receive signal information for an identified channel only if a receive signal strength measurement exceeds a threshold receive signal strength level and only if a receive signal-to-noise ratio exceeds a threshold signal-to-noise ratio level.

14. A method for auto-detection of channel spacings for broadcast bands, comprising:
scanning a plurality of possible channels for a plurality of broadcast bands, each broadcast band having a different channel spacing and representing a different geographic region and each broadcast band at least in part overlapping each other broadcast band;
determining receive signal information for the plurality of possible channels;
analyzing the receive signal information;
automatically selecting a channel spacing representing a selected broadcast band from the plurality of broadcast bands based upon the analyzed receive signal information; and
subsequently using the selected channel spacing to search for channels within the selected broadcast band.

15. The method of claim 14, wherein the determining step comprises determining receive signal strength for scanned channels or determining signal-to-noise ratio for scanned channels or determining both receive signal strength and signal-to-noise ratio for scanned channels.

16. The method of claim 14, wherein the scanning step comprises scanning channels at a first channel spacing associated with a first broadcast band and scanning channels at a second channel spacing associated with a second broadcast band, wherein the determining step comprises determining a received signal strength for each scanned channel, wherein the analyzing step comprises comparing a number of channels for each channel spacing that exceed a threshold level of signal strength, and wherein the selecting step comprises selecting the channel spacing having more channels that exceed the threshold level.

17. The method of claim 14, wherein the scanning step comprises scanning at a 1 kHz channel spacing, wherein the determining step comprises determining a received signal strength for each scanned channel, wherein the analyzing step comprises identifying channels that exceed a threshold level of signal strength and determining frequency differences between identified channels, and wherein the selecting step comprises selecting a channel spacing based upon the frequency differences.

18. An AM receiver system having auto-detection of channel spacing for AM broadcast bands, comprising:
an AM receiver configured to be tuned to receive channels within a plurality of different AM broadcast bands in a plurality of geographic regions with each AM broadcast band having a different channel spacing, to determine receive signal information for received channels, and to receive scan control input signals;
a host system coupled to the AM receiver and configured to provide the scan control signals to the AM receive and to use the scan control signals to control the AM receiver to scan a plurality of possible channels for the plurality of AM broadcast bands, the host system being further configured to obtain receive signal information for the plurality of possible channels from the AM receiver, to analyze the receive signal information, to select a channel spacing representing a selected AM broadcast band from the plurality of AM broadcast bands based upon the analyzed receive signal information, and subsequently to use the selected channel spacing to control the AM receiver for subsequent channel scanning within the selected AM broadcast band.

19. The AM receiver system of claim 18, wherein the plurality of AM broadcast bands comprise a first AM broadcast band for a first geographic region having a 9 kHz channel spacing and a second AM broadcast band for a second geographic region having a 10 kHz channel spacing.

20. The AM receiver system of claim 19, wherein the host system is further configured to use the scan control signals to control the AM receiver to scan channels using the 9 kHz channel spacing and using the 10 kHz channel spacing, the host system being further configured to select the channel spacing having more scanned channels that exceed a threshold signal strength level.

21. The AM receiver system of claim 20, wherein the host system is further configured to use the scan control signals to control the AM receiver to skip channels within the 9 kHz channel spacing and the 10 kHz channel spacing that are overlapping channels with respect to each other.

22. The AM receiver system of claim 19, wherein the host system is further configured to use the scan control signals to control the AM receiver to scan using a 1 kHz channel spacing, the host system being further configured to select the 9 kHz channel spacing or the 10 kHz channel spacing based upon frequency differences between scanned channels that exceed a threshold signal strength level.

23. The AM receiver system of claim 22, wherein the host system is further configured to use the scan control signals to control the AM receiver to skip channels within the 9 kHz channel spacing and the 10 kHz channel spacing that are overlapping channels with respect to each other.

24. The AM receiver system of claim 16, wherein the receive signal information comprises receive signal strength for scanned channels or signal-to-noise ratio for scanned channels or both receive signal strength and signal-to-noise ratio for scanned channels.
